(19) United States
(12) Patent Application Publication
(10) Pub. No.: US 2022/0177176 A1
(43) Pub. Date: Jun. 9, 2022

(54) EZ Fill Bag Holder

(71) Applicant: Owen Lee Alberson, Theodore, AL (US)

(72) Inventor: Owen Lee Alberson, Theodore, AL (US)

(21) Appl. No.: 17/178,885

(22) Filed: Feb. 18, 2021

Related U.S. Application Data
(60) Provisional application No. 63/205,387, filed on Dec. 7, 2020.

(51) Int. Cl. B65B 67/12; B65F 1/14

(52) U.S. Cl. CPC B65B 67/1233; B65F 2240/138; B65F 1/1415

(57) ABSTRACT

A device whose purpose is to hold a lawn trash bag upright and open for easy fill up with leaves, lawn clippings, recyclables, or any yard or beach debris and dean up. It holds up to a 55 gallon capacity. It is constructed of heavy, durable plastic yet is light weight and easy to manage. It consists of four interlocking pieces to assemble for use and disassemble for storage.

### CROSS REFERENCE TO RELATED APPLICATIONS

The present application claims priority to U.S. Provisional Patent Application Ser. No. 63/207,387, filed Dec. 7, 2020, the entirety of which is incorporated herein by reference.

### BACKGROUND OF THE INVENTION

The present invention relates generally to a bag holder, and more specifically to a bag holder to hold a lawn trash bags.

### BRIEF SUMMARY OF THE INVENTION

The present invention's purpose is to hold a law n trash bag upright and open for easy fill up with leaves, lawn clippings, recyclables or any yard or beach debris. It w ill hold up to a 55 gallons capacity and is constructed of durable plastic yet that is light weight and easy to manage. It consists of four interlocking pieces to assemble for use and disassemble for storage.

### BRIEF DESCRIPTION OF THE DRAWINGS

FIG. 1 is an exploded view of the present invention as well as a bottom view of the baseplate;

FIG. 2 is a perspective view of the present invention in use.

FIG. 3 is a top view of the stretching lock strap.

### DETAILED DESCRIPTION

The invention will now be described more fully with reference to the accompanying drawings. Dimensions of the components of the invention are in inches, unless indicated otherwise, indicated by the abbreviation (″).

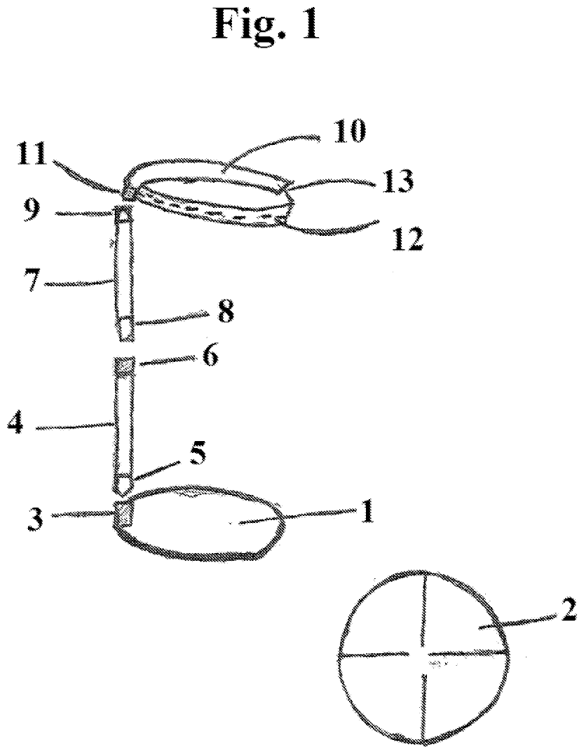

Referring to FIG. 1, a bag holder is illustrated in an exploded view and a bottom view, respectively. The bag holder comprises an 18″×1.5″ round baseplate 1 having a countersunk bottom and a 2.5″×1.5″×2.5″ female socket 3 at a back portion of the baseplate. The female socket 3 receives a 2.5″×1.5″×2.5″ male socket insert 5 at a bottom end of a 2.5″×1.5″×17″ bottom vertical support 4. The bottom vertical support 4 has a 2.5″ deep female socket 6 at a top end into which is inserted a 2.5″×1.5″×2.5″ male socket insert 8 at a bottom end of a 2.5″×1.5″×17″ top vertical support 7. At a top end of the top vertical support 7, there is another 2.5″×1.5″×2.5″ male socket insert 9 which is received by a 2.5″×1.5″×2.5″ female socket 11 on a back of an 18″×3″ top collar 10 which has an 0.5″ wide external groove for receiving a 56.5″ stretching lock strap 12. The top collar 10 has a throat opening 13 for easy insertion and removal of a plastic bag, wherein a top of the throat opening is 6″ wide and a bottom of the throat opening is 10″ wide, such that the opening comprises two slanted edges.

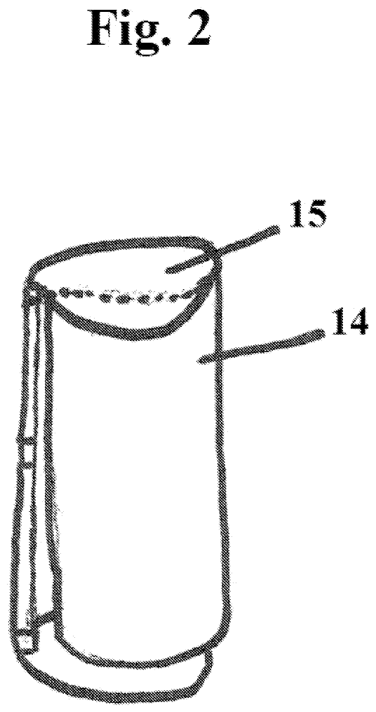

As illustrated in FIG. 2, the bag holder supports a strong 0.2 mm thick 55 gallon plastic bag 14, measuring 3 feet×4 feet. The bag has an opening 15.

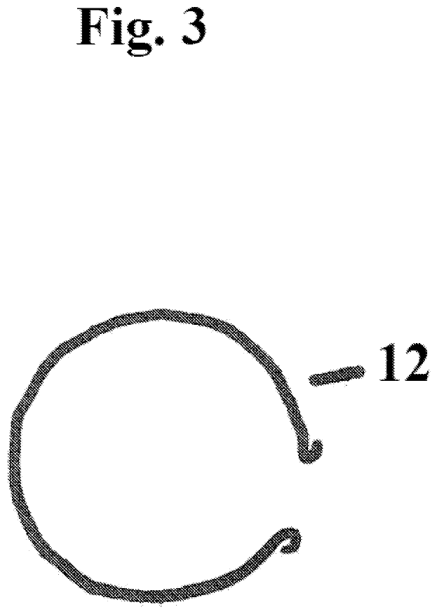

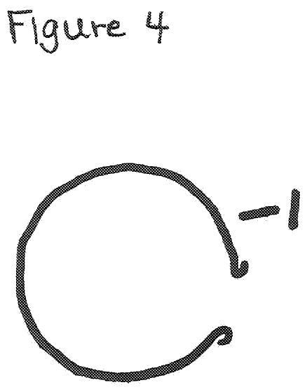

FIG. 3 shows a top view of the stretching lock strap 12 which is received in the external groove of the top collar 10.

1. A bag holder device consisting of:
a round baseplate having a countersunk bottom configured to allow level setting of the baa holder device and stability, and a female socket at a rear portion;
a bottom vertical support removably secured to said baseplate via a male insert, wherein the bottom vertical support has a length of 17 inches;
a top vertical support removably secured to a female socket of said bottom vertical support, wherein the too vertical support has a length of 17 inches;
a collar removably secured to said top vertical support, wherein the collar has a top edge, a bottom edge, and a throat opening configured to receive a plastic bag, wherein a top of the throat opening has a width of 6 inches and a bottom of the throat opening has a width of 10 inches, such that the throat opening forms two slanted edges each extending between the to edge and bottom edge on either side of the throat opening, wherein the collar has a diameter of 18 inches and a width between the too edge and bottom edge of 3 inches;
a stretching lock strap having a length of 56.5 inches and being configured to stretch around said collar to removably secure a elastic bag to the bag holder device; and
wherein said collar has an extremal 0.5 inch wide groove to accommodate the stretching lock strap.

2. (canceled)

3. (canceled)

4. (canceled)

6. (canceled)

7. (canceled)

8. (canceled)

9. (canceled)
